(19) United States
(12) Patent Application Publication
(10) Pub. No.: US 2014/0068638 A1
(43) Pub. Date: Mar. 6, 2014

(54) SYSTEM AND METHOD FOR APPLICATION LOADING

(71) Applicant: PANTECH CO., LTD., Seoul (KR)

(72) Inventor: Myung Hwan SEO, Seoul (KR)

(73) Assignee: PANTECH CO., LTD., Seoul (KR)

(21) Appl. No.: 13/949,741

(22) Filed: Jul. 24, 2013

(30) Foreign Application Priority Data
Sep. 5, 2012 (KR) 10-2012-0098045

(51) Int. Cl. G06F 9/54

(52) U.S. Cl. CPC G06F 9/542
USPC 719/318

(57) ABSTRACT

A method for selective application loading includes monitoring an element of an operating environment, determining whether the element of the operating environment corresponds to an execution condition, and executing an application corresponding to the execution condition. An application control system includes a condition controller to store an execution condition, to monitor an operating condition of a terminal, and to determine whether the operating condition meets the execution condition; and an event controller to execute a corresponding application if the operating condition meets the execution condition.

### CROSS-REFERENCE TO RELATED APPLICATION

This application claims priority from and the benefit under 35 U.S.C. §119(a) of Korean Patent Application No. 10-2012-0098045, filed on Sep. 5, 2012, the entire disclosure of is incorporated herein by reference for all purposes.

### BACKGROUND

1. Field

The following description relates to a linkage application control system and method of controlling an application loading.

2. Discussion of the Background

An application is, generally, an abbreviation of an application program.

The application program may refer to a program designed to enable a user or other application programs to execute a predetermined operation. Examples of the application program may include a word processor, a database program, a web browser, a development tool, an image generating program (e.g., paint brush), an image editing program, a communication program, and the like.

The application may employ an operating system of a computer and a service of other supporting programs.

An application may execute an independent operation based on an input according to a related art.

Due to such a characteristic of the application, selecting of several options or inputting a repetitive value is required in order to set various execution methods and conditions to the application.

For example, in order to verify bus information, a user may obtain desired information through operations of inputting several values, selecting a menu, and the like. The user may perform these operations by executing an application providing information of a bus location, and may repeat such operations as necessary.

Further, the user may need to select a current area to obtain a desired result to verify information of a current bus location at a current time. Since a subject being input needs to be aware of a value of the current location, and each value needs to be inputted repeatedly, the conventional application may lack readiness for use.

### SUMMARY

Exemplary embodiments of the present invention provide a linkage application control system and method of controlling an application loading.

Additional features of the invention will be set forth in the description which follows, and in part will be apparent from the description, or may be learned by practice of the invention.

Exemplary embodiments of the present invention provide a method for selective application loading including monitoring an element of an operating environment; determining whether the element of the operating environment corresponds to an execution condition; and executing an application corresponding to the execution condition.

Exemplary embodiments of the present invention provide an application control system including a condition controller to store an execution condition, to monitor an operating condition of a terminal, and to determine whether the operating condition meets the execution condition; and an event controller to execute a corresponding application if the operating condition meets the execution condition.

Exemplary embodiments of the present invention provide a method for selective application loading including storing event information for an event corresponding to an execution condition; monitoring an element of an operating environment; determining whether the element of the operating environment corresponds to the execution condition; executing an application corresponding to the execution condition; and executing the event with respect to the application.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating a linkage application control system according to an exemplary embodiment of the present invention.

FIG. 2 is a diagram illustrating a condition applied to a linkage application control system according to an exemplary embodiment of the present invention.

FIG. 3 is a diagram illustrating recommending and selectively registering an application corresponding to a predetermined condition according to an exemplary embodiment of the present invention.

FIG. 4 is a diagram illustrating setting of a condition for a linkage application control system according to an exemplary embodiment of the present invention.

FIG. 5 is a diagram illustrating storing an event type for a linkage application control system according to an exemplary embodiment of the present invention.

FIG. 6 is a diagram illustrating a condition event table to store event information according to an exemplary embodiment of the present invention.

FIG. 7 is a diagram illustrating a system architecture of a linkage application control system according to an exemplary embodiment of the present invention.

FIG. 8 is a flowchart illustrating a linkage application control method according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

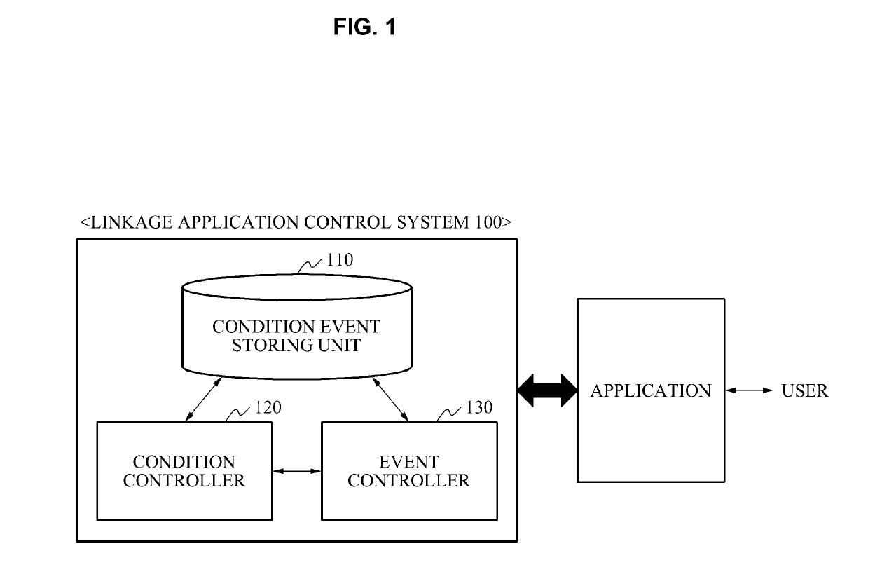

FIG. 1 is a block diagram illustrating a linkage application control system 100 according to an exemplary embodiment of the present invention.

When an application to be executed is set with respect to one or more conditions, which may include, without limitation, at least one of a predetermined time, location, weather, date, and the like, the linkage application control system 100 may identify and provide information relevant to a user. The linkage application control system 100 may more rapidly and more conveniently provide such information by executing an appropriate or corresponding application when matched to a particular condition or a set of conditions. These particular condition or set of conditions may be provided by, without limitation, a user, an external system, a service provider, a manufacturer, a programmer, or determined according to at least one of an operating environment, observed pattern/routine, and external environment.

As used herein, a system may refer to an apparatus in which several components may be disposed, and in which such components may interact with each other to execute a predetermined information processing operation based on one or more conditions.

Aspects of the invention may be described by identifying an application to be executed under a particular condition. Such application may be, without limitation, referred to as a linkage application.

For example, when a user rides or uses a particular bus at a particular bus stop, and at a particular time on a consistent basis while commuting, a user using an application according to a related art may need to execute an application and input a value or select a menu to verify bus line information used by the user.

However, when a condition and an application are set using the linkage application control system 100, the application may be executed in advance to inform the user of an arrival time for a bus at a bus stop, at a time set by the user.

Referring to FIG. 1, the linkage application control system 100 includes a condition event storing unit 110, a condition controller 120, and an event controller 130.

The condition controller 120 may determine whether a device enters an environment corresponding to an execution condition by monitoring one or more registered conditions or condition elements. The execution condition may be predetermined. The execution condition may include meeting of a single registered condition element or a combination of registered condition elements.

For example, the condition controller 120 may monitor an operating environment of a terminal, and may determine whether the operating environment being monitored corresponds to the execution condition.

Based on a result of the determination of the condition controller 120, when the operating environment, which may be monitored, is determined to correspond to the execution condition, the event controller 130 may execute a corresponding linkage application. Further, the event controller 130 may execute the corresponding linkage application, such that event information with respect to a linkage application may be executed. The event information may include operations corresponding to one or more user inputs that may be executed on the linkage application when the linkage application is registered. The user inputs may include, without limitation, a touch, a hard key, and the like. The event information may be executed sequentially. For example, the event information may include selecting of a certain menu options, such that when the event information is applied to the linkage application, the selection of certain menu options are automatically selected for the linkage application.

Accordingly, information that may be relevant to the user may be delivered without a specific input under a predetermined condition.

More particularly, the condition event storing unit 110 may store event information corresponding to an execution condition.

For example, the predetermined condition may refer to information with respect to at least one of a location condition element, a temperature condition element, a time condition element, a date condition element, a weather condition element, and the like. The event information may refer to control information that may control a driven application or the linkage application.

The condition controller 120 may monitor an operating environment, and may determine whether the operating environment, which may be monitored, corresponds to an execution condition. Also, the event controller 130 may drive a linkage application based on a result of the determination when the operating environment corresponds to the execution condition.

Further, the condition controller 120 may store a condition inputted by a user, which may include one or more condition elements, monitor the operating environment, such as a time element, a location element, a weather element, and the like, of a system, and may determine whether the monitored elements, which may include at least one of a time element, a location element, a weather element, and the like, correspond to a registered or execution is condition.

For example, the condition controller 120 may monitor an operating environment by verifying or determining at least one of a location element, a temperature element, a time element, a date element, and a weather element.

More particularly, the condition controller 120 may operate in conjunction with at least one of a global positioning system (GPS), a network access point, and the like, in verifying or determining a location element.

Further, the condition controller 120 may receive a signal from at least one of the GPS and the network access point to verify or determine a current location.

When a specified location element is recorded as a condition element of the execution condition in the condition event storing unit 110, the condition controller 120 may verify or determine whether the current location or the monitored location element corresponds to the recorded location condition element.

Further, the condition controller 120 may use an application program interface (API) provided by a weather-related website to verify or determine the weather element.

The condition controller 120 may receive weather-related information through the API provided by the weather-related website, and verify or determine at least one of weather conditions and temperature.

When the weather element or the temperature element is recorded as a condition element of the execution condition in the condition event storing unit 110, the condition controller 120 may verify or determine whether the monitored weather element or the temperature element, which may be received or determined through the API, corresponds to the recorded condition element.

The event controller 130 may drive a linkage application based on a result of the determination of the condition controller 120 when the operating environment corresponds to the execution condition.

When a linkage application is driven, the event controller 130 may control the driven application to perform a predetermined event by applying the stored event information.

The stored event information may refer to, without limitation, a control command of an application that may be provided in advance. For example, the stored event information may be inputted by a user in advance.

The event controller 130 may receive a control signal with respect to an application from the user. Further, the event controller 130 may create and store event information, based on the received control signal.

The control signal may embody various forms of events without limitation, such as a touch input, a key input, and the like, on a screen driven by an application. Further, the stored event information may refer to an operation event in an execution component including an application in an open source method in advance.

The event controller 130 may collect at least one execution component present in an application. Further, the event controller 130 may control the at least one execution component to execute a predetermined event by applying event information and selectively operating the at least one execution component that may be collected.

With recent development of an operating system of a smart device, by embodying or applying the predetermined event through selectively operating the execution component, resolving an issue of entering a menu and searching for a total of corresponding applications to execute rather than roaming around several applications to operate using a multitasking operation is may be possible.

For example, a user may edit and use a linkage application by creating the linkage application unique to the user through collecting an execution component for a unique environment or purpose of the user.

The linkage application control system 100 may provide a user interface for registering and managing of a linkage application to be executed under a new condition. Further, the linkage application control system 100 may also include a linkage application managing unit (not shown) to execute an operation of managing/supervising the condition controller 120 and the event controller 130.

According to exemplary embodiments of the present invention, when an application to be executed by a user under an execution condition, which may include at least one of a location condition element, a weather condition element, a date condition element, and the like, information relevant to the user may be provided by automatically executing a corresponding application when matched to the predetermined condition.

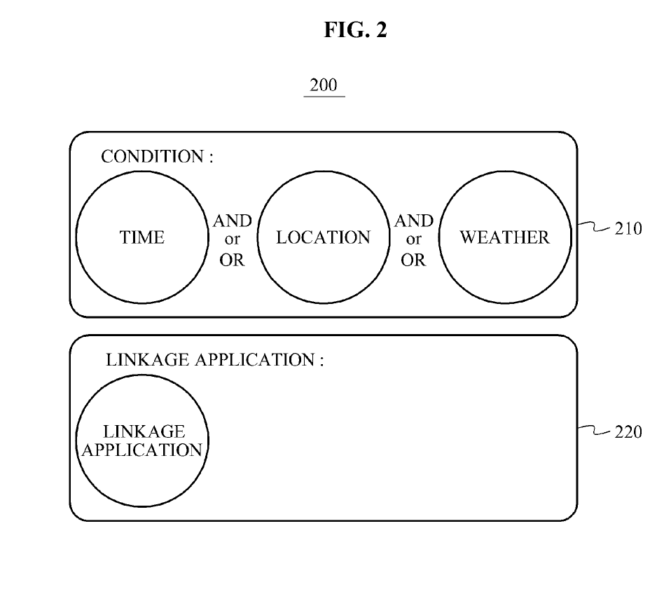

FIG. 2 is a diagram illustrating a condition applied to a linkage application control system according to an exemplary embodiment of the present invention.

The linkage application control system 200 may input, without limitation, information with respect to at least one of a time condition element, a location condition element, and a weather condition element as condition 210, which may be compared to an operating state to determine a corresponding linkage application.

The information with respect to at least one of the time condition element, the location condition element, and the weather condition element may be connected by an “AND” or an “OR” logic structure or operator. However, aspects of the invention are not limited thereto, is such that they may be connected using a different logic structure, such as various conditions including ranges, exceptions, limits, and the like.

For example, the condition 210 may be compared to the operating state. More specifically, the time condition element and the location condition element may be connected by the “AND” operator or logic structure, such that the time condition element and the location condition element may both correspond to those of the operating state. Further, the weather condition element may be connected by the “OR” operator or logic structure, such that verification as to whether the weather condition element corresponds to that of the operating state is performed, aside from the time condition element and the location condition element.

Accordingly, the linkage application control system may drive a linkage application 220 when the operating state being monitored corresponds to the information input.

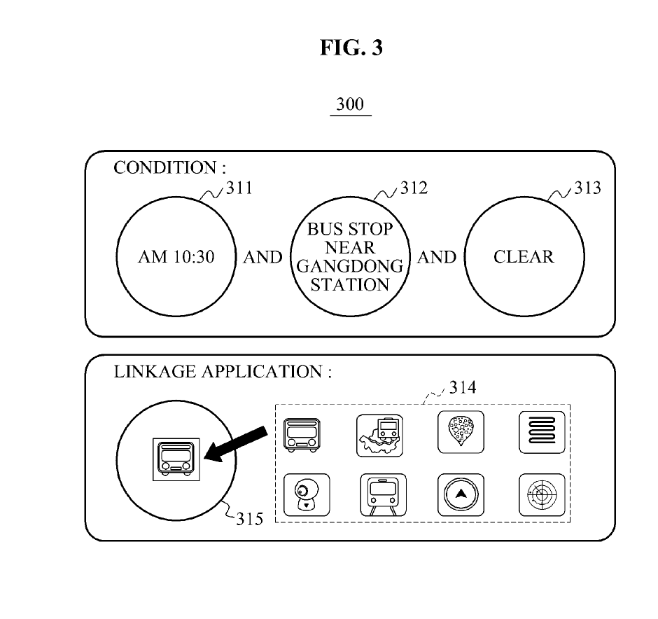

FIG. 3 is a diagram illustrating recommending and selectively registering an application corresponding to an execution condition according to an exemplary embodiment of the present invention.

A linkage application control system 300 may compare at least one of the condition elements to an element of an operating state. The linkage application control system 300 may receive an input of information with respect to at least one of a time condition element 311, a location condition element 312, and a weather condition element 313.

More particularly, the linkage application control system 300 may receive an input of “AM 10:30” as information with respect to the time condition element 311, “bus stop near Gangdong Station” as information with respect to the location condition element 312, and “Clear” as information with respect to the weather condition element 313.

Further, referring to FIG. 3, the linkage application control system 300 may be is driven when the input condition elements are connected by an “AND” logic structure and each of the three condition elements is satisfied.

More specifically, the linkage application control system 300 may drive a linkage application 315 when the operating state being monitored corresponds to the inputted condition elements.

For example, when receiving an input of information with respect to at least one of the time condition element 311, the location condition element 312, and the weather condition element 313, the linkage application control system 300 may extract applications associated with the time condition element 311, the location condition element 312, and the weather condition element 313 and may recommend at least one of corresponding linkage applications to a user. However, aspects of the invention are not limited thereto, such that the linkage application control system 300 may automatically execute the at least one of corresponding linkage applications when appropriate conditions are met.

Further, when the user selects the time condition element 311, the location condition element 312, and the weather condition element 313, the linkage application control system 300 may recommend one or more applications that the user may select as the linkage application associated with at least one of the selected time condition element 311, the location condition element 312, and the weather condition element 313.

In this example, the linkage application control system 300 may create a recommendation list 314 through an event controller.

More specifically, the event controller according to an exemplary embodiment of the present invention may receive an input of at least one condition element from a user, and extract at least one linkage application corresponding to the at least one inputted condition is element.

Also, the event controller may create an application recommendation list 314 using at least one extracted application.

The user may set a condition to be compared and an application to be executed when that condition is met. The user may use the set condition and the set application as shown in FIG. 3. The event controller may evaluate and classify a characteristic of one or more applications and create an application recommendation list 314, which the user may use to select one or more applications. More specifically, the user may use the application recommendation list 314 by verifying or determining permission information for one or more applications. The permission information may be verified to assist the user in selecting an application among numerous applications that may be available.

For example, an application configured to be executed at a specified location may be classified as a linkage application. A location condition element may be set using location information, such as bus routes, subway routes, information provided by a navigation system, and the like. If the location information inputted by the user or obtained by the terminal is determined to have met the set location condition element, permissions of the linkage application may be verified or determined for execution.

When permission of such applications is verified or determined, permission with regard to a GPS capability may be considered.

The event controller may refer to an application having permission of the GPS capability when selecting a linkage application, and may recommend an application based the location information, such as bus routes, subway routes, the navigation system, and the like.

Frequently used permission among varied permission may be as follows.

Permission using an overall location based on a network or a detailed location of the GPS may have a higher probability of being involved with an application associated with the location condition element.

Also, permission for correcting and deleting Internet browsing data may have a higher probability of being involved with an application associated with a network communication operation. Permission for correcting and deleting secure digital (SD) card contents may have a higher probability of being involved with an application associated with storing operation.

Further, permission for reading a mobile phone status and identification (ID) may correspond to an application associated with a phone call operation. Permission for photographing and recording videos may have a higher probability of being involved with an application associated with hardware control operation.

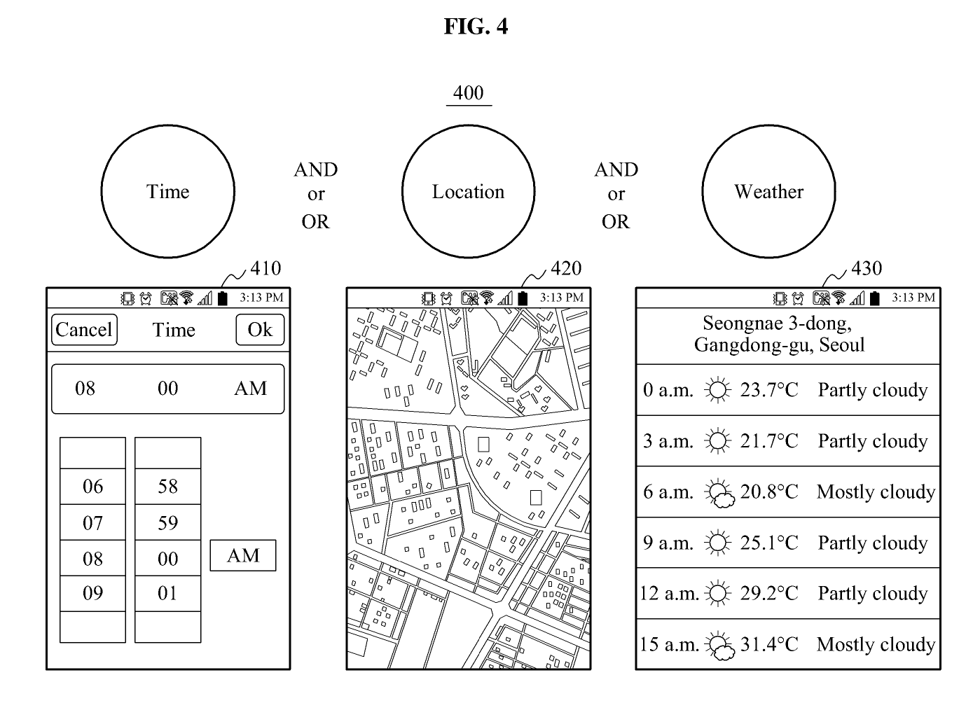

FIG. 4 is a diagram illustrating setting of a condition for a linkage application control system according to an exemplary embodiment of the present invention.

A linkage application managing unit may select one or more condition elements, which may include at least one of a time condition element, a location condition element, and a weather condition element. The linkage application managing unit may further select a combination with respect to effects of one or more condition elements, which may be connected by at least one of an “AND” and an “OR” logic structure or operator.

A user may use a number of condition elements, which may range from 1 to 3 in setting a condition. However, aspects of the invention are not limited thereto, such that more than 3 condition elements may be used. When the user selects a condition setting operation provided by the linkage application managing unit, an option screen 400 of FIG. 4 may be displayed. When the user selects the time condition element, a user interface 410, in which a time condition element is set, may be displayed to set a specific time. However, aspects of the invention are not limited thereto, such that a time frame or range may be specified.

When the user selects the location condition element, a user interface 420 in which a location is selected through a map may be displayed. When the user selects a location on the map as a location condition element in the user interface 420, a coordinate with respect to the selected location may be stored. However, aspects of the invention are not limited thereto, such that a user may select a particular bus or train stop on a transportation map (e.g., a bus route map, a subway route map, or the like).

The weather condition element may be a condition element corresponding to the location condition element, and the user may select from various weather conditions that may be available for selection, such as clear, cloudy, rainy, and snowy in a user interface 430. However, aspects of the invention are not limited thereto, such that weather conditions for other locations may be available for selection. Further, a temperature range may be provided for selection.

Such a combination may vary according to a correlation of one or more condition elements. Referring to FIG. 4, when a combination of “AM 10:30” as a time condition element AND “Gangdong Station Stop” as a location condition element AND “snowing” as a weather condition element, the linkage application may be executed when each of three condition elements are met.

However, when a combination of “AM 10:30” as a time condition element OR “Gangdong Station Stop” as a location condition element OR “snowing” as a weather condition element, the linkage application may be executed when at least one of these condition elements is met.

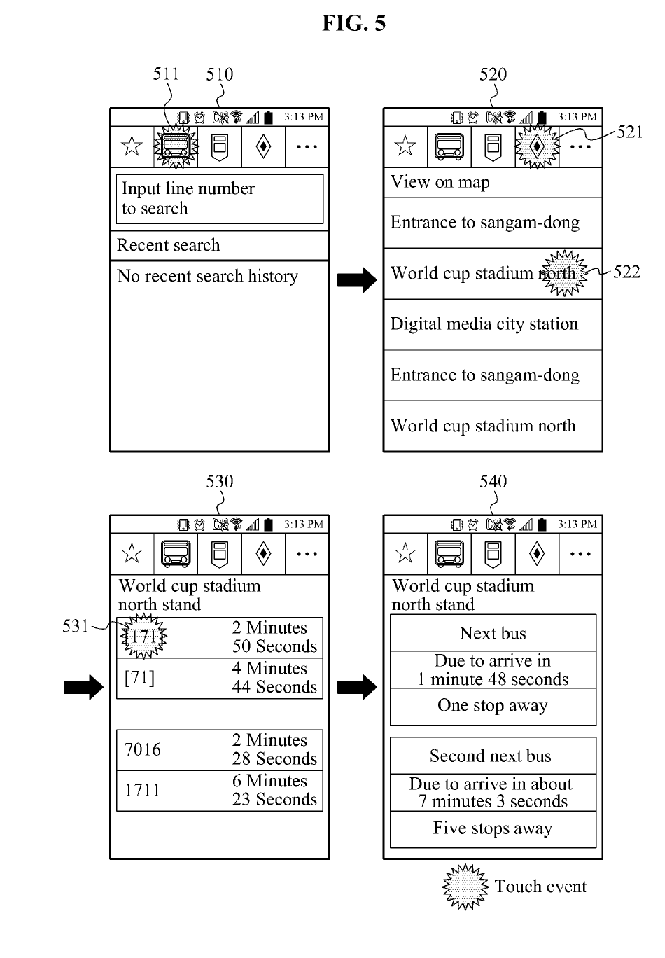

FIG. 5 is a diagram illustrating storing an event type for a linkage application control system according to an exemplary embodiment of the present invention.

When an application to be registered is selected, an event controller according to an exemplary embodiment of the present invention may execute an application. A user may input a value, such as a menu selection option, and may select a menu or sub-menu until a resulting value or a particular configuration of an application to be used repeatedly by the user is obtained.

When the inputting operation is completed, the event controller may store information associated with provided input as event information, which may include at least a touch, pressing of a hard key, and the like in event information. The event information may include a sequence of menu selections, selected options, and the like, which may be used to navigate to a targeted application screen or configuration.

For example, referring to FIG. 5, an initial screen 510 of a bus information application may be automatically converted or directed to a search screen 520 by automatically selecting a bus search menu 511. More specifically, the initial screen 510 may be automatically converted or directed to the search screen 520 by the stored event information. The stored event information may further navigate the user to screen 530 and screen 540. Here, the event information may refer to menu selection or option selection as illustrated by markers 521, 522, and 531, which correspond to a touch event. Accordingly, when event information is applied to the bus information application in response to meeting an execution condition, operations 521, 522, and 531 may be automatically be performed to direct the user from the initial screen 510 to the resulting screen 540.

Further, when the user rides bus 171 at a World Cup Stadium North Stand bus is stop on a daily or frequent basis, a plurality of selection inputs may be automatically provided in a sequence of reference numeral 521 to 522 based on the stored event information. Operation 521 may indicate a touch event with respect to viewing of bus stations, and operation 522 may indicate a touch event with respect to a selection of a particular bus stop.

The initial screen 510 may be converted or directed to a search result screen 530 by the plurality of selection inputs that may be automatically provided by the stored event information to display a bus list.

When a bus searched for on the bus list is found, such as bus 171, the user may typically provide a touch input on the bus 171 to display a final result screen 540. However, a selection input 531 may be automatically generated to display a final result screen 540 based on the stored event information.

Accordingly, referring to the final result screen 540, the user may verify that a next bus 171 coming toward the World Cup Stadium North Stand bus stop is due to arrive in one minute and 48 seconds, and is currently one stop away.

The application may store event information, and provide a resulting value by automatically executing one or more selection inputs in an application under an execution condition using the stored event information without an additional input by the user.

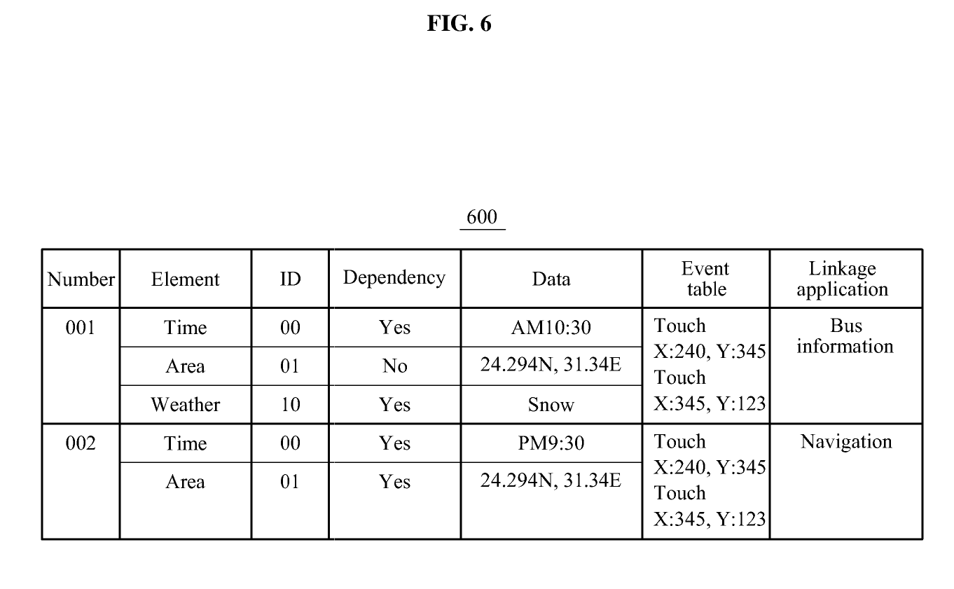

FIG. 6 is a diagram illustrating a condition event table to store event information according to an exemplary embodiment of the present invention.

Referring to FIG. 6, event table 600 includes a number field, an element field, an identification (ID) field, a dependency field, a data field, an event table field, and a linkage application field.

The number field may record numerical information for displaying a sequence is assigned to an event. Also, the number field may be utilized as identification information for managing an addition and a deletion of a corresponding event.

The element field may record information for distinguishing a condition element with respect to one or more condition elements, such as a time condition element, an area condition element, and a weather condition element.

The ID field may record the identifier information that may identify one or more condition elements. The dependency field may record whether a condition element is dependent on another condition element.

More specifically, when a “yes” value is recorded in the dependency field, the condition element may be verified to be compared with another condition element. Further, a dependency on another condition element may be determined based on a selection of an “AND” or an “OR” logic structure or operator when a condition element is set.

The data field may record detailed information with respect to one or more condition elements.

For example, information of “AM 10:30” may be recorded as data with respect to a time condition element.

Also, the event table field may record detailed information with respect to an event set by the user.

For example, the event table field may record information with respect to a coordinate on a screen, and the like, as information with respect to a touch event inputted by the user.

Further, the event table field may store a direct execution command configured by a single component configuring one or more screens of an application.

More particularly, the applications may include a reference execution component as portions configuring one or more screens.

The reference execution component may refer to a single user interface screen being viewed by the user as a dividing unit for one or more user interface that may be executed by the user at a start of an application. The reference execution component may be interpreted as an activity in an Android® operating system, a view controller in an iOS® operating system, a page in a Windows® operating system, and the like.

By storing and using the direct execution command with respect to the reference execution component in the event table, the user may collect an execution component of an application for a unique environment or purpose of the user. The collected execution components of the application may be used to create a unique application configuration. More specifically, the collected execution components may be used to edit the application to create a unique application configuration and to use the created application.

When the user inputs a plurality of touches as an event, a corresponding coordinate values may be recorded in the event table field. However, aspects of the information are not limited thereto, such that corresponding commands corresponding to the touches may be recorded in the event table field.

The event table field may further record information to identify an application that may be executed when a touch associated with the touched coordinate value occurs.

Further, a touch event occurring on an execution screen of an application may be verified.

For example, the event table field may further record information with respect to an executed application when a touch corresponding to the coordinate is inputted, which may is include a time interval at which the touch occurs, and the like.

Also, the linkage application may record information with respect to an executed application when condition elements making up a condition are satisfied.

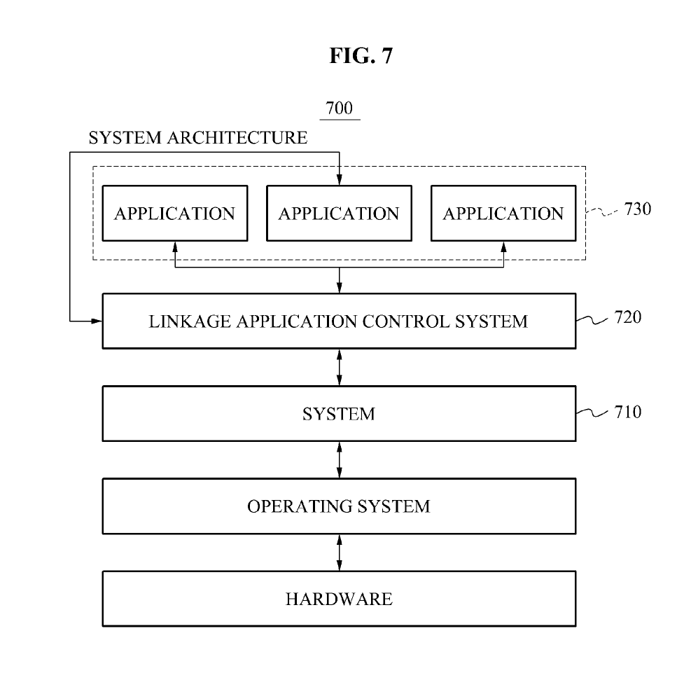

FIG. 7 is a diagram illustrating a system architecture of the linkage application control system according to an exemplary embodiment of the present invention.

Referring to FIG. 7, the system architecture 700 includes a system 710, a linkage application control system 720, an application layer 730, an operating system 740, and a hardware layer 750. The linkage application control system 720 may obtain a conditional value used for creating a story table and executing the linkage application to the system 710, and manage an execution sequence, and the like, while being driven between a system 710 and an application layer 730.

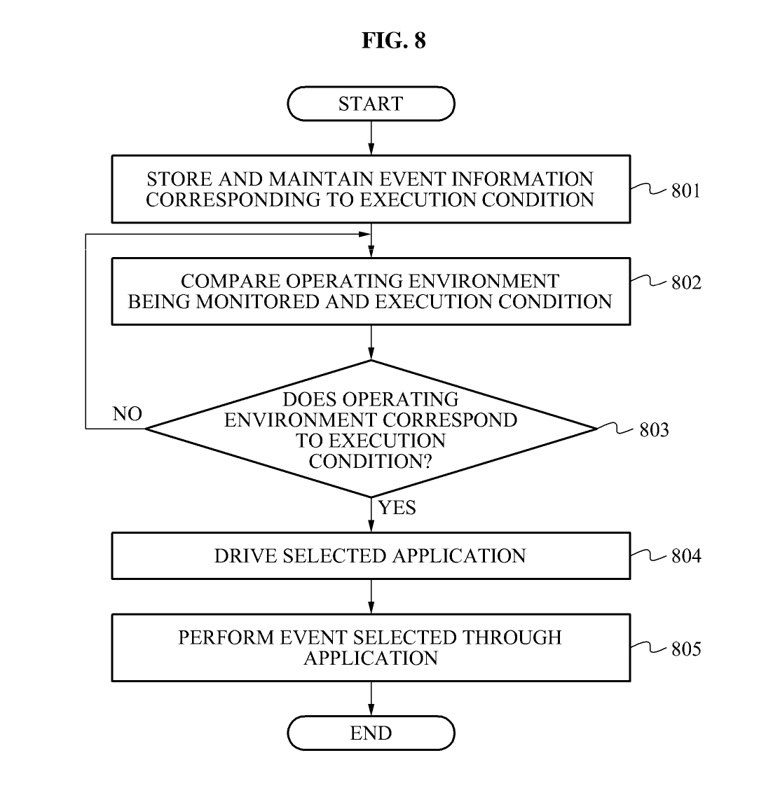

FIG. 8 is a flowchart illustrating a linkage application control method according to an exemplary embodiment of the present invention.

In operation 801, the linkage application control method may store event information corresponding to a predetermined condition, and maintain the stored event information.

For example, the linkage application control method may receive a control signal from a user, which may be used to create and store the event information.

The linkage application control method may monitor an operating environment. For example, the linkage application control method may monitor the operating environment by verifying, determining, or obtaining at least one of a location element, a temperature element, a time element, a date element, and a weather element.

In operation 802, the linkage application control method may verify the operating is environment being monitored and the execution condition, and determine whether the operating environment being monitored corresponds to the execution condition in operation 803.

In operation 804, the linkage application control method may drive a linkage application when the operating environment being monitored is determined to correspond to the execution condition. The linkage application may be a predetermined application.

In operation 805, the linkage application control method may control the linkage application to perform a predetermined event by applying the stored event information.

The linkage application control method may collect at least one execution component present in an application to control the linkage application to perform the predetermined event.

Also, the linkage application control method may control a device to perform the predetermined event by applying event information and selectively operating the at least one collected execution component.

The linkage application control method may provide a group of candidate applications that may be selected as the linkage application. The group of candidate applications may correspond to an inputted condition and may be provided in an application recommendation list.

The linkage application control method may receive an input of at least one condition element, extract at least one application corresponding to the at least one condition element, and create the application recommendation list using the at least one extracted application.

Based on the linkage application control method that may control execution of an application, when an application to be executed under an execution condition is set, information is requested or sought by a user may be provided by automatically executing a corresponding application when matched to the execution condition. The execution condition may include at least one of a time condition element, a location condition element, a weather condition element, a date condition element, and the like.

Execution conditions may be applied in various manners by using one or more of the condition elements. Further, execution conditions may be applied by creating a combination of the condition elements using an “AND” and an “OR” logic structures or operators based on the linkage application control method.

Also, based on the linkage application control method, selecting of several menu options and repetitive inputting may be made unnecessary or reduced. More specifically, the linkage application control method may use one or more pieces of information matched to a condition for executing an application relevant to the user, which may be obtained by selecting several related applications.

Further, based on the linkage application control method, repetitive or multiple menu selections for executing several applications may be reduced, and an operation based on a condition, which may be changed within a boundary set by the user, may be possible.

Based on the linkage application control method, a new operation story may be created since a registration and management with respect to a new application may be possible.

Based on the linkage application control method, time and effort may further be reduced by at least performing one of setting, storing, and using a short key with respect to a series of operations when the linkage application is executed repeatedly. Further, a repetitive result may be obtained with more convenience by regularly executing a set story at a specified time.

According to exemplary embodiments of the present invention, when an application is set to be executed under an execution condition, which may include at least one of a time condition element, a location condition element, a weather condition element, a date condition element, and the like, it may be possible to provide information requested or sought by a user by automatically executing a corresponding application when matched to the execution condition.

According to exemplary embodiments of the present invention, it may be possible to use one or more condition elements and apply the condition elements in various manners by creating a combination using at least one of an “AND” and an “OR” logic structure or operators.

According to exemplary embodiments of the present invention, based on the linkage application control method, selecting several menu options and repetitive inputting may be made unnecessary or reduced by using one or more pieces of information matched to a condition of executing an application desired or sought by the user, obtained by selecting several related applications.

According to exemplary embodiments of the present invention, it may be possible to reduce repetitive or multiple menu selections for executing several applications.

According to exemplary embodiments of the present invention, it may be possible to operate based on a condition, which may be changed within a boundary set by a user.

According to exemplary embodiments of the present invention, a new operation story may be created by a registration and management with respect to a new application.

According to exemplary embodiments of the present invention, time and effort may further be reduced by performing at least one of setting, storing, and using a short key with respect to a series of operations when a linkage application is executed repeatedly.

According to exemplary embodiments of the present invention, it may be possible to obtain a repetitive result more conveniently by executing a set story regularly at a specified time.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media, such as hard disks, floppy disks, and magnetic tape; optical media, such as compact disc (CD) read only memory (ROM) discs and digital versatile disc (DVD); magneto-optical media, such as floptical discs; and hardware devices that are specially configured to store and perform program instructions, such as ROM, random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their is equivalents.

What is claimed is:

1. A method for selective application loading, comprising:
monitoring an element of an operating environment;
determining whether the element of the operating environment corresponds to an execution condition; and
executing an application corresponding to the execution condition.

2. The method of claim 1, wherein the execution condition comprises a condition element or a combination of condition elements.

3. The method of claim 1, further comprising:
storing event information corresponding to the execution condition.

4. The method of claim 3, further comprising:
performing an event by applying the event information.

5. The method of claim 3, wherein the event information comprises a sequence of operations to be performed.

6. The method of claim 2, further comprising:
receiving a selection of at least one condition element; and
extracting at least one application corresponding to the at least one condition element.

7. The method of claim 6, further comprising:
generating an application recommendation list comprising the extracted application.

8. The method of claim 7, wherein the recommendation list is generated with respect to a permission of the application.

9. The method of claim 7, further comprising:
selecting the application from the application recommendation list.

10. An application control system, comprising:
a condition controller to store an execution condition, to monitor an operating condition of a terminal, and to determine whether the operating condition meets the execution condition; and
an event controller to execute a corresponding application if the operating condition meets the execution condition.

11. The application control system of claim 10, wherein the execution condition comprises a condition element or a combination of condition elements.

12. The application control system of claim 10, wherein the execution condition comprises at least one of a location condition element, a temperature condition element, a time condition element, a date condition element, and a weather condition element.

13. The application control system of claim 10, further comprising:
a condition event storing unit to store event information corresponding to the execution condition.

14. The application control system of claim 13, wherein the event controller controls the application to perform an event by applying the event information.

15. The application control system of claim 13, wherein the event information comprises a sequence of operations to be performed.

16. The application control system of claim 11, wherein the event controller receives a selection of at least one condition element, and extracts at least one application corresponding to the at least one condition element.

17. The application control system of claim 16, wherein the event controller generates an application recommendation list comprising the extracted application.

18. The application control system of claim 17, wherein the application recommendation list is generated with respect to a permission of the application.

19. The application control system of claim 13, wherein the event controller collects at least one execution component included in the application and controls the at least one execution component to execute an event by applying the event information.

20. A method for selective application loading, comprising:
storing event information for an event corresponding to an execution condition;
monitoring an element of an operating environment;
determining whether the element of the operating environment corresponds to the execution condition;
executing an application corresponding to the execution condition; and
executing the event with respect to the application.
